(19) United States
(12) Patent Application Publication
(10) Pub. No.: US 2026/0063810 A1
(43) Pub. Date: Mar. 5, 2026

(54) RADIATION IMAGING APPARATUS

(71) Applicant: CANON KABUSHIKI KAISHA, Tokyo (JP)

(72) Inventors: YOSHITAKA OTSUBO, Kanagawa (JP); TAKAAKI GONDA, Kanagawa (JP); TOMOHIRO HOSHINA, Kanagawa (JP); AKIRA KIDA, Kanagawa (JP)

(21) Appl. No.: 19/304,318

(22) Filed: Aug. 19, 2025

(30) Foreign Application Priority Data
Sep. 4, 2024 (JP) 2024-152275

(51) Int. Cl. G01T 1/20

(52) U.S. Cl. CPC G01T 1/20188; G01T 1/20182

(57) ABSTRACT

A radiation imaging apparatus includes a radiation detection sensor configured to detect radiation, an electric circuit board, a first base including a radiation shielding member located between the radiation detection sensor and the electric circuit board, the first base being configured to support the electric circuit board, a housing containing the radiation detection sensor, the electric circuit board, and the first base in an internal space of the housing, and a first fixing portion configured to fix the first base to a back surface of the housing so that the electric circuit board faces the back surface of the housing with a gap in the internal space, wherein the first fixing portion is located in an area inside an outer periphery of the radiation shielding member in a planar view along a radiation incident direction.

### BACKGROUND

### Field of the Technology

The present disclosure relates to a radiation imaging apparatus.

### Description of the Related Art

A radiation imaging apparatus irradiating a target object with radiation and detecting an intensity distribution of the radiation that has transmitted through the target object to obtain a radiation image is widely and generally used in fields of industrial non-destructive inspections and medical diagnoses. In general, the radiation imaging apparatus includes a radiation detection sensor that detects radiation, a sensor support base that supports the radiation detection sensor, an electric circuit board on which various kinds of integrated circuits (ICs) are mounted, and the like.

In the radiation imaging apparatus, in a case where the ICs mounted on the electric circuit board are irradiated with high-intensity radiation, the radiation can cause malfunctions of the ICs and/or deteriorations of their properties. Thus, a radiation shielding member is provided between the radiation detection sensor and the electric circuit board as discussed in Japanese Patent Application Laid-Open No. Hei 9-152486.

With the configuration discussed in Japanese Patent Application Laid-Open No. Hei 9-152486, the radiation shielding property can be secured. However, since the electric circuit board is not sufficiently fixed to a housing of the electric circuit board and the radiation shielding member is spaced apart from the electric circuit board, the sensor support base is not sufficiently fixed to the housing. Thus, there may be a deterioration of mechanical strength such as an impact resistance and a vibration resistance of the electric circuit board or the radiation detection sensor, and there is a concern that the breakage of these components may be caused.

Japanese Patent Application Laid-Open No. 2002-116261 discusses a radiation imaging apparatus including a sensor substrate having a pixel area, a sensor support base supporting the sensor substrate, and a support base supporting a radiation shielding member. In the radiation imaging apparatus described above, the support base is fixed to an inner surface of a housing by a columnar portion to fix the support base to the housing of the sensor substrate. On the other hand, a gap is formed in the electric circuit board for inserting and positioning the columnar portion of the support base, and a mounting plate is provided at an end portion of the gap to fix the electric circuit board to the housing. However, the configuration in which the mounting plate is directly provided at the end portion of the electric circuit board is not suitable for the apparatus configuration including the support base supporting the electric circuit board. For this reason, with this apparatus configuration, the support base supporting the electric circuit board cannot be stably held, and the mechanical strength appropriate for the electric circuit board cannot be achieved.

### SUMMARY

The present disclosure is made in consideration of the issue described above. The present disclosure is directed to a radiation imaging apparatus capable of satisfying both a high radiation shielding property for an electric circuit board and a sufficient mechanical strength for a radiation detection sensor and an electric circuit board, in a configuration including a support base supporting the electric circuit board.

According to an aspect of the present disclosure, a radiation imaging apparatus includes a radiation detection sensor configured to detect radiation, an electric circuit board, a first base including a radiation shielding member located between the radiation detection sensor and the electric circuit board, the first base being configured to support the electric circuit board, a housing containing the radiation detection sensor, the electric circuit board, and the first base in an internal space of the housing, and a first fixing portion configured to fix the first base to a back surface of the housing so that the electric circuit board faces the back surface of the housing with a gap in the internal space, wherein the first fixing portion is located in an area inside an outer periphery of the radiation shielding member in a planar view along a radiation incident direction.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-section diagram illustrating an example of a radiation imaging apparatus according to a first exemplary embodiment.

FIG. 2 is a cross-section diagram illustrating a radiation imaging apparatus according to a comparative example of the first exemplary embodiment.

FIG. 3 is a cross-section diagram illustrating an example of a radiation imaging apparatus according to a second exemplary embodiment.

FIG. 4 is a cross-section diagram illustrating an example of a radiation imaging apparatus according to a third exemplary embodiment.

FIG. 5 is a cross-section diagram illustrating an example of a radiation imaging apparatus according to a fourth exemplary embodiment.

### DESCRIPTION OF THE EMBODIMENTS

### —Basic Configuration of Radiation Imaging Apparatus According to Exemplary Embodiments—

Before disclosing specific exemplary embodiments, a basic configuration of a radiation imaging apparatus according to the exemplary embodiments will be described.

The radiation imaging apparatus includes a radiation detection sensor that detects radiation, electric circuit boards, a radiation shielding member located between the radiation detection sensor and the electric circuit boards, and a first base supporting the electric circuit boards. Further, the radiation imaging apparatus includes a housing containing the radiation detection sensor, the electric circuit boards, and the first base in an internal space of the housing. In the configuration described above, a first fixing portion that fixes the first base to a back surface of the housing is provided so that the electric circuit boards face the back surface of the housing with a gap in the internal space of the housing. The first fixing portion is located in an area inside the outer periphery of the radiation shielding member in a planar view along a radiation incident direction. In a case where the first fixing portion is arranged outside the outer periphery of the radiation shielding member, sufficient mechanical strength cannot be achieved because the first base is fixed in an unbalanced and unstable manner by the first fixing portion. This becomes particularly noticeable in a case where the radiation imaging apparatus is large. By arranging the first fixing portion in the inner area, both a high radiation shielding property for the electric circuit boards and a mechanical strength for the electric circuit boards supported by the first base fixed to the housing, and eventually for the radiation detection sensor appropriately fixed to the housing via the first base can be satisfied.

Further, the radiation imaging apparatus may desirably include a second base supporting the radiation detection sensor, and a second fixing portion that fixes the second base in the internal space of the housing. With this configuration, the first base is fixed to the housing in a state where the first base, the radiation shielding member, and the second base are integrally fixed, and thus both a high radiation shielding property and a sufficient mechanical strength for the electric circuit boards and the radiation detection sensor can be achieved. Specific examples of such configurations include the following configurations (1) to (4).

### Configuration (1)

The second fixing portion is provided so as to penetrate the radiation shielding member. For example, a gap is formed in the radiation shielding member, and the second fixing portion is arranged so as to pass through the gap. The second base faces the first base via the radiation shielding member, and the second fixing portion connects the first base and the second base. With this configuration, the first base, the radiation shielding member, and the second base are firmly and integrally fixed, which contributes to further improving the mechanical strength. Details of this configuration will be described below according to a first exemplary embodiment.

### Configuration (2)

The second fixing portion is an adhesive material, and adhesive materials are provided on both surfaces of the radiation shielding member to bond and fix one surface of the radiation shielding member and the first base, and the other surface of the radiation shielding member and the second base. With this configuration, the first base, the radiation shielding member, and the second base are integrally fixed, which contributes to further improving the mechanical strength. Details of this configuration will be described below according to a second exemplary embodiment.

### Configuration (3)

The second fixing portion is a buffer member, and buffer members are arranged, for example, between the upper surface of the radiation detection sensor supported by the second base and the front surface of the housing (first configuration), and/or between the side surface of the second base and the side surface of the housing (second configuration). With the first configuration, an upper portion of the second base supporting the radiation detection sensor contacts the housing via the buffer member, and a lower portion thereof contacts the first base via the radiation shielding member. Thus, the second base is stably held in a floating state inside the housing to suppress displacement and an external impact particularly in the longitudinal direction. In the second configuration, since the side surface of the second base supporting the radiation detection sensor contacts the housing via the buffer member and the second base is stably held in a floating state inside the housing, displacement and an influence of the external impact can be suppressed particularly in the lateral direction. By using both of the first and second configurations, the second base is more stably held in the floating state inside the housing, and the displacement and the influence of the external impact in the longitudinal and lateral directions are suppressed. In this case, in the first configuration, the buffer member and the front surface of the housing (and further the buffer member and the radiation shielding member) may be fixed, and in the second configuration, the buffer member and the side surface of the housing may be fixed. By adopting such a fixed state, more stable holding can be achieved.

### Configuration (4)

The first base is configured with the radiation shielding member. More specifically, the first base does not have the radiation shielding member as a separate member, and the first base is made of a material including a radiation shielding material. The second base is easily fixed to the first base fixed to the housing and having a high radiation shielding function, and thus is fixed together with the first base to the housing. With this configuration, a secure radiation shielding function can be achieved by the first base with the number of components reduced and having a simple structure, and thus, the mechanical strength can be improved.

### —Specific Descriptions of Exemplary Embodiments—

Hereinafter, exemplary embodiments of the present disclosure will be described in detail with reference to the drawings. The following exemplary embodiments do not limit the disclosure according to the scope of the claims. Although a plurality of features is described in the exemplary embodiments, not all of the plurality of features are necessarily essential, and the plurality of features may be combined in any suitable manner. Furthermore, in the drawings, the same or similar components are denoted by the same reference numerals, and redundant description thereof will be omitted. The details of the dimensions and structures illustrated in the exemplary embodiments are not limited to those illustrated in the text and drawings. In the present specification, the radiation includes not only X-rays but also α-rays, β-rays, γ-rays, particle beams, cosmic rays, and the like.

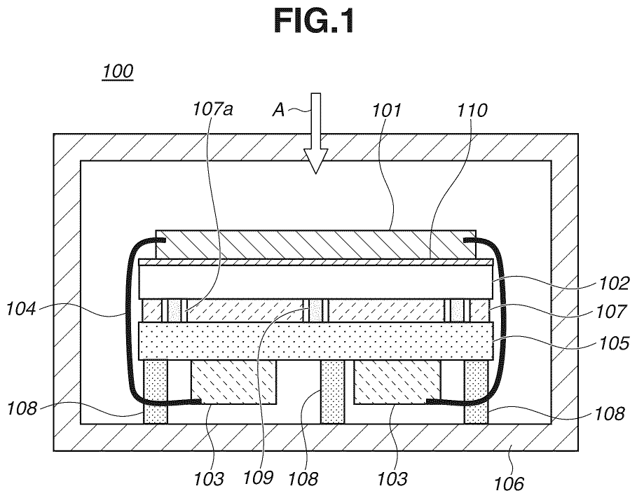

Hereinbelow, a first exemplary embodiment will be described with reference to the attached drawings. FIG. 1 is a cross-section diagram illustrating an example of a radiation imaging apparatus 100 according to the present exemplary embodiment.

The radiation imaging apparatus 100 includes a sensor panel 101, a sensor support base 102, electric circuit boards 103, a flexible wire 104, a circuit support base 105, and a housing 106 containing them therein.

The sensor panel 101 is a radiation detection sensor, and may be, for example, a digital radiography (DR) sensor. The sensor panel 101 includes a plurality of pixels, and each pixel generates an electrical signal corresponding to a radiation dose incident thereon. The configuration of the sensor panel 101 may be a known configuration, and an example thereof will be described below. Each pixel of the sensor panel 101 is formed by disposing a switch element such as a thin film transistor (TFT), a photoelectric conversion portion, and a scintillator layer on an insulating substrate such as a glass substrate. The photoelectric conversion portion can be made of amorphous silicon (a-Si), low-temperature polycrystalline silicon (LTPS), an oxide semiconductor (IGZO), or the like.

The incident radiation is converted into visible light by the scintillator layer, and the visible light is converted into electric charges by the photoelectric conversion portion. Cesium iodide (CsI), gadolinium oxysulfide (GOS or Gd₂O₂S: Tb), or the like may be used for the scintillator layer. In particular, thallium (Tl) or natrium (Na) may be used as an activator for CsI. The scintillator layer is covered with a protective film such as a poly-para-xylylene (parylene) resin film, a hot-melt resin film, or a laminated sheet made of a hot-melt resin and aluminum. Instead of the scintillator layer, each pixel may include a conversion portion containing a material that directly converts the radiation into electric charges or the like. As the material, amorphous selenium (a-Se), cadmium telluride (CdTe), cadmium zinc telluride (CdZnTe), or the like is suitable.

The sensor support base 102 is a second base for supporting the sensor panel 101 and supports the lower surface of the sensor panel 101 on a radiation incident surface (upper surface) side thereof, a radiation incident direction to which is indicated by an arrow A.

A material such as resin, carbon fiber reinforced plastic (CFRP), magnesium alloy, aluminum alloy, sheet steel, or stainless steel may be used for the sensor support base 102 to satisfy both stiffness and lightness in weight, and the sensor support base 102 may be configured with a plurality of components.

On the electric circuit boards 103, various integrated circuits (ICs) are mounted, such as a driver IC that transmits an electrical signal to drive the sensor panel 101 and an amplifier IC that amplifies an electrical signal detected by the sensor panel 101. The flexible wire 104 is a wire that electrically connects the sensor panel 101 and the electric circuit boards 103.

The circuit support base 105 is a first base that supports the plurality of electric circuit boards 103. The electric circuit boards 103 are arranged on the lower surface of the circuit support base 105 as illustrated in FIG. 1, and a radiation shielding member 107 having a layered structure is provided on the upper surface of the circuit support base 105. The radiation shielding member 107 is a member that absorbs or shields part of radiation emitted from a radiation source, corresponds to an imaging effective pixel area of the sensor panel 101, and is located at a position and has a size to cover the plurality of electric circuit boards 103 in a planar view along a radiation incident direction indicated by the arrow A. As a high radiation shielding material, the radiation shielding member 107 desirably includes one or more metallic materials selected from the group consisting of lead (Pb), barium (Ba), tantalum (Ta), tungsten (W), and molybdenum (Mo). By providing the radiation shielding member 107 that is a simple single member having an excellent radiation shielding property, even in the case where the plurality of electric circuit boards 103 is provided, the radiation emission toward the electric circuit boards 103 is shielded, and malfunction and property degradation of the ICs due to the radiation emission are prevented. The radiation shielding member 107 is arranged so as to be sandwiched between the circuit support base 105 and the sensor support base 102.

The circuit support base 105 supports the plurality of electric circuit boards 103 on the back side thereof in the radiation incident direction A. The circuit support base 105 can satisfy both stiffness and lightness in weight by using a material such as resin, CFRP, magnesium alloy, aluminum alloy, sheet steel, or stainless steel.

The housing 106 is a casing member containing the sensor panel 101, the sensor support base 102, the electric circuit boards 103, the flexible wire 104, the circuit support base 105, and the like in an internal space thereof. The housing 106 can satisfy both stiffness and lightness in weight by using a material such as CFRP (Carbon Fiber Reinforced Polymer), magnesium alloy, aluminum alloy, iron, or stainless steel.

In the present exemplary embodiment, first columnar members 108 are provided as the first fixing portion that fixes the sensor support base 102 to the back surface of the housing 106 so that the electric circuit boards 103 face the back surface of the housing 106 with a gap in the internal space of the housing 106. More specifically, the circuit support base 105 is formed of the metallic material or the resin material described above, and, for example, the hollow first columnar members 108 separate from the circuit support base 105 are, for example, press-fitted and embedded in the lower surface of the circuit support base 105 in FIG. 1. The first columnar members 108 may be formed of the same metallic material as that of the circuit support base 105, or a metallic material different from that of the circuit support base 105 from among the metallic materials described above. Further, instead of the configuration of embedding the first columnar members 108 in the circuit support base 105, the circuit support base 105 may be formed integrally with the first columnar members 108 using, for example, a predetermined resin material so that the first columnar members 108 protrude from the surface of the circuit support base 105. In this way, it is possible to easily obtain the radiation imaging apparatus 100 according to the present exemplary embodiment by using the circuit support base 105 excellent in convenience and appropriately provided with the first columnar members 108.

In the internal space of the housing 106, an end surface of each of the first columnar members 108 is in contact with and fixed to the back surface of the housing 106 so that the first columnar members 108 are in an upright state. Each of the first columnar members 108 is fastened and fixed by inserting, for example, a screw so as to penetrate the housing 106, one of the first columnar members 108, and the circuit support base 105 from the rear surface of the outer face of the housing 106, and fixing the screw with, for example, a nut on the upper surface of the circuit support base 105. In this way, the circuit support base 105 holding the electric circuit boards 103 is firmly fixed to the housing 106, and sufficient mechanical strength is ensured for the electric circuit boards 103.

The first columnar members 108 are arranged in an area inside the outer periphery of the radiation shielding member 107, at positions where no ICs are arranged (hereinbelow, sometimes referred to as an IC non-arranged area), and spaced apart from the ICs on the electric circuit boards 103 in a planar view along the radiation incident direction A. In the case where the first columnar members 108 are arranged as described above, it is assumed that the first columnar members 108 are arranged at a plurality of positions as illustrated in FIG. 1, but only one of the first columnar members 108 may be arranged at a position.

By arranging the first columnar members 108 in the area inside the outer periphery of the radiation shielding member 107, a stable fixation of the circuit support base 105 to the housing 106 can be achieved with reduced imbalance in the fixing positions. By arranging the first columnar members 108 at positions spaced apart from the ICs on the electric circuit boards 103, interference of the first columnar members 108 with the ICs is prevented. In the example in FIG. 1, the first columnar members 108 are arranged in a gap portion between the adjacent electric circuit boards 103. For example, in a case where the electric circuit boards 103 have relatively large areas, through-holes may be formed at positions spaced apart from the ICs on the electric circuit boards 103, and the first columnar members 108 may be arranged so as to pass through the through-holes. By arranging the first columnar members 108 as described above, the circuit support base 105 can be stably fixed to the housing 106 without hindering functions of the ICs on the electric circuit boards 103.

Further, in the present exemplary embodiment, second columnar members 109 that fix the sensor support base 102 and the circuit support base 105 with the radiation shielding member 107 interposed therebetween by penetrating through the radiation shielding member 107 are provided as a second fixing portion. More specifically, the circuit support base 105 is formed of the metallic material or the resin material described above, and, for example, the hollow second columnar members 109 separate from the circuit support base 105 are, for example, press-fitted and embedded therein on the upper surface of the circuit support base 105 in FIG. 1. Thus, in this case, the first columnar members 108 described above are arranged on the lower surface of the circuit support base 105, and the second columnar members 109 are arranged on the upper surface of the circuit support base 105. The second columnar members 109 may be formed of the same metallic material as that of the circuit support base 105, or a metallic material different from that of the circuit support base 105 from among the metallic materials described above. Further, instead of the configuration of embedding the second columnar members 109 in the circuit support base 105, the following configuration may be employed. In this configuration, the circuit support base 105 is formed integrally with the second columnar members 109 using, for example, a predetermined resin material so that the second columnar members 109 protrude from a main surface on one side of the circuit support base 105. Alternatively, the circuit support base 105 may be formed integrally with the second columnar members 109 using, for example, a predetermined resin material so that the second columnar members 109 protrude from the main surface on one side and the first columnar members 108 protrude from a main surface on the other side. As described above, it is possible to easily obtain the radiation imaging apparatus 100 according to the present exemplary embodiment by using the circuit support base 105 excellent in convenience and appropriately provided with the first columnar members 108 and the second columnar members 109.

The second columnar members 109 may be arranged on the lower surface of the sensor support base 102 in FIG. 1 instead of being arranged on the circuit support base 105. More specifically, the sensor support base 102 is formed of the metallic material described above, and, for example, the hollow second columnar members 109 separate from the sensor support base 102 are embedded in the lower surface of the sensor support base 102 in FIG. 1. The second columnar members 109 may be formed of the same metallic material as that of the sensor support base 102, or a metallic material different from that of the sensor support base 102 from among the metallic materials described above. Further, the sensor support base 102 may be formed integrally with the second columnar members 109 using, for example, a predetermined resin material so that the second columnar members 109 protrude from the surface of the sensor support base 102. In this way, it is possible to easily obtain the radiation imaging apparatus 100 according to the present exemplary embodiment by using the sensor support base 102 excellent in convenience and appropriately provided with the second columnar members 109.

In the radiation shielding member 107, a gap 107a is formed at a position corresponding to each of the second columnar members 109. The gap 107a is formed wider than each of the corresponding second columnar members 109 so that the second columnar members 109 are not in contact with and do not interfere with the radiation shielding member 107. Each of the second columnar members 109 is inserted into the corresponding gap 107a in a state of being spaced apart from an inner wall surface of the corresponding gap 107a as illustrated in FIG. 1, and the sensor support base 102 and the circuit support base 105 are fixed with the second columnar members 109.

More specifically, the sensor support base 102 and the circuit support base 105 are fastened and fixed by inserting, for example, a screw so as to penetrate the circuit support base 105, one of the second columnar members 109, and the sensor support base 102 from the lower surface of the circuit support base 105, and the screw is fixed with, for example, a nut on the upper surface of the sensor support base 102. Alternatively, the sensor support base 102 and the circuit support base 105 are fastened and fixed by inserting, for example, a screw so as to penetrate the sensor support base 102, one of the second columnar members 109, and the circuit support base 105 from the upper surface of the sensor support base 102, and fixing the screw with, for example, a nut on the lower surface of the circuit support base 105. In this way, the sensor support base 102 holding the sensor panel 101 is firmly fixed to the circuit support base 105 via the radiation shielding member 107, and a sufficient mechanical strength is ensured for the sensor panel 101.

As described above, the sensor panel 101, the sensor support base 102, the radiation shielding member 107, the circuit support base 105, and the electric circuit boards 103 are integrally fixed. Since the circuit support base 105 is fixed to the housing 106 by the first columnar members 108, all of the sensor panel 101, the sensor support base 102, the radiation shielding member 107, the circuit support base 105, the electric circuit boards 103, and the like are fixed to the housing 106.

As described above, in the present exemplary embodiment, the sensor support base 102 holding the sensor panel 101 is fixed to the circuit support base 105 via the radiation shielding member 107, and the circuit support base 105 holding the electric circuit boards 103 is fixed to the housing 106 by the first columnar members 108. In this way, the sensor panel 101 and the electric circuit boards 103 are fixed to the housing 106 via the sensor support base 102 and the circuit support base 105. Thus, both the high radiation shielding property for the electric circuit boards 103 and the sufficient mechanical strength for the sensor panel 101 and the electric circuit boards 103 can be satisfied.

The second columnar members 109 are arranged in the imaging effective pixel area of the sensor panel 101 and in the IC non-arranged areas where no ICs are arranged on the electric circuit boards 103, in a planar view along the radiation incident direction A. In the case where the second columnar members 109 are arranged as described above, it is assumed that the second columnar members 109 are arranged at a plurality of positions as illustrated in FIG. 1, but only one of the second columnar members 109 may be arranged at a position. By arranging the second columnar members 109 in the imaging effective pixel area, imbalance of fixing positions of the sensor support base 102 with respect to the circuit support base 105 can be prevented, and the sensor support base 102 can be stably fixed. By arranging the second columnar members 109 in the IC non-arranged areas of the electric circuit boards 103 where no ICs are mounted in the planar view, the radiation emission toward an IC due to an overlap of the gap 107a, where the radiation shielding member 107 is not present, with the IC can be prevented. By arranging the second columnar members 109 as described above, the sensor support base 102 can be stably fixed to the circuit support base 105 without hindering the functions of the ICs mounted on the electric circuit boards 103.

The first columnar members 108 and the second columnar members 109 may desirably be arranged at different positions that do not overlap each other in a planar view along the radiation incident direction A. With such an arrangement, stress applied to the sensor support base 102 and the circuit support base 105 by the first columnar members 108 and the second columnar members 109 is dispersed. Accordingly, the stable fixing of the sensor support base 102 and the circuit support base 105 to the housing 106 is achieved.

In addition, a radiation shielding member 110 having a layered structure may additionally be arranged between the sensor panel 101 and the sensor support base 102. By arranging the radiation shielding member 110, reflection from the ICs mounted on the electric circuit boards 103 or the like can be prevented from being captured in a captured image.

### COMPARATIVE EXAMPLE

Now, a comparative example of the present exemplary embodiment will be described.

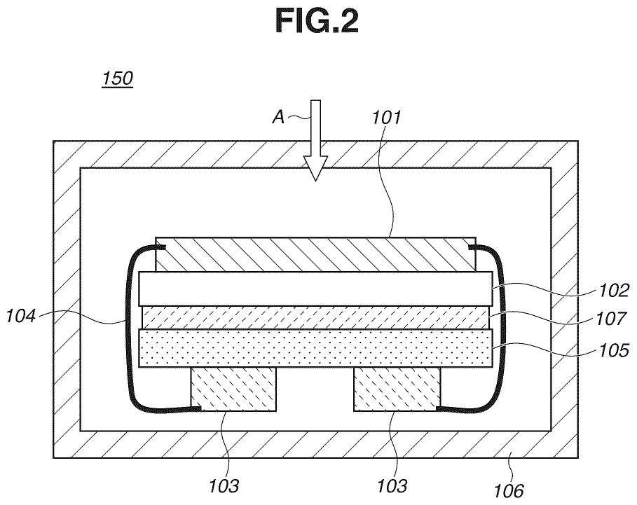

FIG. 2 is a cross-section diagram illustrating a radiation imaging apparatus 150 according to the comparative example of the present exemplary embodiment. In FIG. 2, the same components as those of the radiation imaging apparatus 100 according to the present exemplary embodiment illustrated in FIG. 1 are assigned the same reference numerals, and descriptions thereof are omitted.

As illustrated in FIG. 2, the radiation imaging apparatus 150 is provided with neither the first columnar members 108 nor the second columnar members 109, which are provided in the radiation imaging apparatus 100 according to the present exemplary embodiment. With this configuration, due to the presence of the radiation shielding member 107, the sensor support base 102 is not appropriately fixed to the circuit support base 105, and, in addition, the circuit support base 105 is not appropriately fixed to the housing 106. In this case, for example, it is conceivable that the sensor support base 102, the circuit support base 105, and the like may be held by, for example, allowing the inner surface of the housing 106 to contact a specific component.

With the configuration of the radiation imaging apparatus 150, the radiation shielding property for the electric circuit boards 103 is secured by the radiation shielding member 107. Neither the circuit support base 105 nor the sensor support base 102 is secured to the housing 106. As a result, the electric circuit boards 103 and the sensor panel 101 supported by these bases are vulnerable to external shocks and vibrations, which can readily undermine their mechanical strength.

On the other hand, since the radiation imaging apparatus 100 according to the present exemplary embodiment is provided with the first columnar members 108 and the second columnar members 109, the sensor support base 102, the circuit support base 105, and the like are securely fixed to the housing 106, and both the radiation shielding property and the mechanical strength are secured.

As described above, according to the present exemplary embodiment, in the configuration including the circuit support base 105 that supports the electric circuit boards 103, the radiation imaging apparatus 100 satisfying both the high radiation shielding property for the electric circuit boards 103 and the sufficient mechanical strength for the sensor panel 101 and the electric circuit boards 103 is achieved.

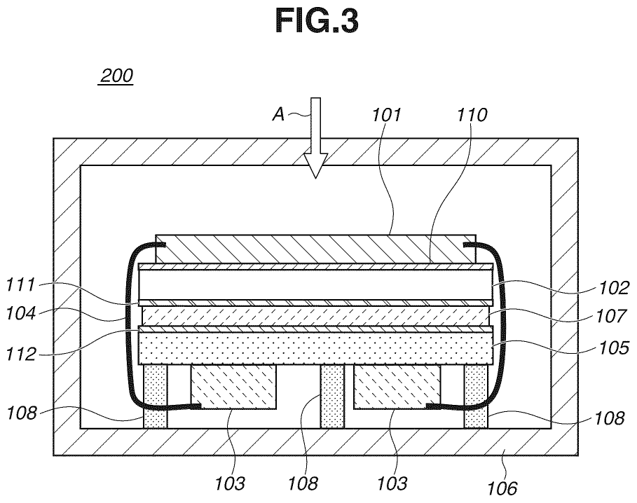

Hereinbelow, a second exemplary embodiment according to the present disclosure will be described. Similar to the first exemplary embodiment, a radiation imaging apparatus is disclosed in the second exemplary embodiment, but the radiation imaging apparatus in the second exemplary embodiment is different from that in the first exemplary embodiment in that the configuration of the second fixing portion is different. FIG. 3 is a cross-section diagram illustrating an example of a radiation imaging apparatus 200 according to the present exemplary embodiment. In FIG. 3, the same components as those of the radiation imaging apparatus 100 according to the first exemplary embodiment illustrated in FIG. 1 are assigned the same reference numerals, and detailed descriptions thereof are omitted.

Similar to the radiation imaging apparatus 100 according to the first exemplary embodiment, the radiation imaging apparatus 200 includes the sensor panel 101, the sensor support base 102, the electric circuit boards 103, the flexible wire 104, the circuit support base 105, and the housing 106 containing them therein. The circuit support base 105 supports the plurality of electric circuit boards 103 and is provided with the radiation shielding member 107 having a layered structure. The first columnar members 108 that fix the circuit support base 105 to the back surface of the housing 106 are provided so that the electric circuit boards 103 face, with a gap, the back surface of the housing 106 opposite to the radiation incident surface in the internal space of the housing 106. The first columnar members 108 are arranged in an area inside the outer periphery of the radiation shielding member 107 and at positions spaced apart from the ICs on the electric circuit boards 103, in a planar view along the radiation incident direction A.

In the present exemplary embodiment, an adhesive material 111 is provided as the second fixing portion between the sensor support base 102 and the radiation shielding member 107, and an adhesive material 112 is provided between the circuit support base 105 and the radiation shielding member 107 as the second fixing portion. For example, as the adhesive materials 111 and 112, glue or a double-sided adhesive tape is used.

The sensor support base 102 is fixed to the circuit support base 105 via the radiation shielding member 107 with the adhesive materials 111 and 112. In this way, the sensor panel 101, the sensor support base 102, the radiation shielding member 107, the circuit support base 105, and the electric circuit boards 103 are integrally fixed. Since the circuit support base 105 is fixed to the housing 106 by the first columnar members 108, all of the sensor panel 101, the sensor support base 102, the radiation shielding member 107, the circuit support base 105, the electric circuit boards 103, and the like are fixed to the housing 106. Thus, both the high radiation shielding property for the electric circuit boards 103 and the sufficient mechanical strength for the sensor panel 101 and the electric circuit boards 103 can be satisfied.

The adhesive materials 111 and 112 do not necessarily need to be provided on entire surfaces of the radiation shielding member 107 and may be provided partially as long as adhesive strength is secured. In this case, more specifically, the adhesive materials 111 and 112 are provided at a position or a plurality of positions on each of the upper and lower surfaces of the radiation shielding member 107 corresponding to the inside of the imaging effective pixel area of the sensor panel 101 in a planar view along the radiation incident direction A. By partially providing the adhesive materials 111 and 112 in the imaging effective pixel area in this way, stable fixation of the sensor support base 102 to the circuit support base 105 is achieved with reduced imbalance in the fixing positions.

As described above, according to the present exemplary embodiment, in the configuration including the circuit support base 105 that supports the electric circuit boards 103, the radiation imaging apparatus 200 satisfying both the high radiation shielding property for the electric circuit boards 103 and the sufficient mechanical strength for the sensor panel 101 and the electric circuit boards 103 is achieved.

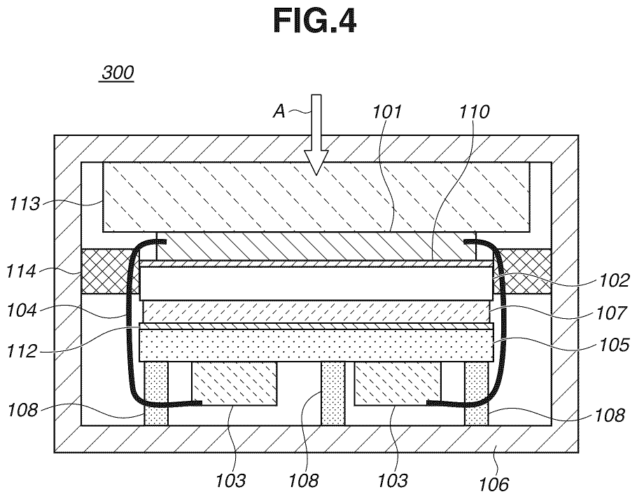

Hereinbelow, a third exemplary embodiment according to the present disclosure will be described. Similar to the first exemplary embodiment, a radiation imaging apparatus is disclosed in the third exemplary embodiment, but the radiation imaging apparatus in the third exemplary embodiment is different from that in the first exemplary embodiment in that the configuration of the second fixing portion is different. FIG. 4 is a cross-section diagram illustrating an example of a radiation imaging apparatus 300 according to the present exemplary embodiment. In FIG. 4, the same components as those of the radiation imaging apparatuses 100 and 200 respectively described in FIGS. 1 and 3 are assigned the same reference numerals, and detailed descriptions thereof are omitted.

Similar to the radiation imaging apparatus 100 according to the first exemplary embodiment, the radiation imaging apparatus 300 includes the sensor panel 101, the sensor support base 102, the electric circuit boards 103, the flexible wire 104, the circuit support base 105, and the housing 106 containing them therein. The circuit support base 105 supports the plurality of electric circuit boards 103 and is provided with the radiation shielding member 107 having a layered structure. The first columnar members 108 that fix the circuit support base 105 to the back surface of the housing 106 are provided so that the electric circuit boards 103 face, with a gap, the back surface of the housing 106 opposite to the radiation incident surface in the internal space of the housing 106. The first columnar members 108 are arranged in an area inside the outer periphery of the radiation shielding member 107 and at positions spaced apart from the ICs on the electric circuit boards 103, in a planar view along the radiation incident direction A.

Similar to the second exemplary embodiment, in the present exemplary embodiment, the adhesive material 112 is provided as a second fixing portion between the circuit support base 105 and the radiation shielding member 107, and the radiation shielding member 107 is bonded and fixed to the circuit support base 105. In this way, the electric circuit boards 103, the circuit support base 105, and the radiation shielding member 107 are fixed to the housing 106.

Further, in the present exemplary embodiment, a cushion member (buffer member) 113 is arranged as a second fixing portion above the sensor support base 102 supporting the sensor panel 101 in the internal space of the housing 106. The lower surface of the cushion member 113 is in contact with the upper surface of the sensor panel 101, and the upper surface of the cushion member 113 is in contact with the front surface of the housing 106. The sensor support base 102 supporting the sensor panel 101 is held and fixed by the cushion member 113 to the housing 106 via the circuit support base 105 and the like in a floating state, to mitigate displacement and an influence of an external impact particularly in a longitudinal direction.

Instead of the cushion member 113 as the second fixing portion, a cushion member 114 may be arranged between a side surface of the sensor support base 102, which supports the sensor panel 101, and a side surface of the housing 106 in the internal space of the housing 106. By the cushion member 114, the sensor support base 102 is held and fixed to the housing 106 in a floating state to mitigate the displacement and the influence of an external impact particularly in a lateral direction. The cushion member 114 may be a frame-shaped member with a part thereof removed and may fill a gap between the side surface of the sensor support base 102 and the side surface of the housing 106 in the internal space of the housing 106 except for a portion through which the flexible wire 104 passes to avoid the interference with the flexible wire 104. Further, the cushion member 114 may be partially provided with a gap other than the portion through which the flexible wire 104 passes, in the gap between the side surface of the sensor support base 102 and the side surface of the housing 106. For example, the cushion member 114 may be partially provided to one or more positions of each of the opposing two sides of the rectangular sensor support base 102, or, in addition thereto, to one or more positions of each of two sides orthogonal to the two sides of the sensor support base 102. By arranging the cushion member 114 in this way, it is possible to stably fix the sensor support base 102 to the housing 106 without imbalance.

Further, both of the cushion members 113 and 114 may be arranged in the internal space of the housing 106 as illustrated in FIG. 4. With this configuration, it is possible to further reduce the displacement of the sensor panel 101 and the sensor support base 102 and the influence of an external impact in the longitudinal and lateral directions.

Furthermore, in the present exemplary embodiment, the cushion member 113 and the front surface of the housing 106 may be fixed, or the cushion member 114 and the side surface of the housing 106 may be fixed. More specifically, they may be fastened and fixed with a screw or bonded and fixed using an adhesive material. By fixing them in this manner, more stable holding is achieved, and the mechanical strength is increased. Further, the upper surface of the radiation shielding member 107 and the lower surface of the sensor support base 102 may be bonded and fixed using, for example, the adhesive material 111 described in the second exemplary embodiment as the second fixing portion to further ensure the mechanical strength.

Further, similar to the first exemplary embodiment, to prevent the reflection from the ICs on the electric circuit boards 103 from being captured in the captured image, the radiation shielding member 110 having a layered structure may be provided between the sensor panel 101 and the sensor support base 102.

As described above, according to the present exemplary embodiment, in the configuration including the circuit support base 105 that supports the electric circuit boards 103, the radiation imaging apparatus 300 satisfying both the high radiation shielding property for the electric circuit boards 103 and the sufficient mechanical strength for the sensor panel 101 and the electric circuit boards 103 is achieved.

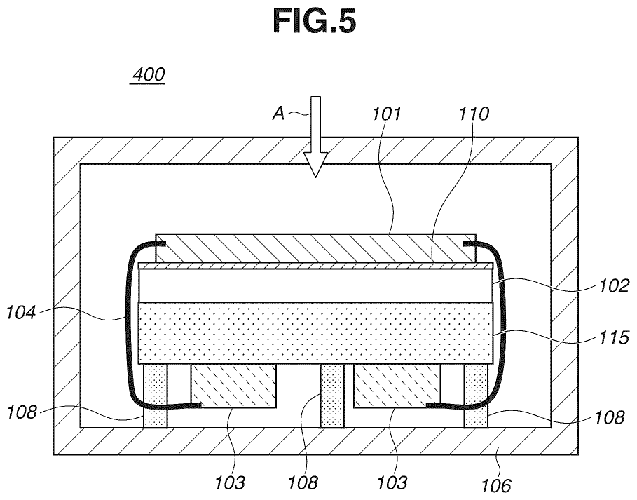

Hereinbelow, a fourth exemplary embodiment according to the present disclosure will be described. Similar to the first exemplary embodiment, a radiation imaging apparatus is disclosed in the fourth exemplary embodiment, but the radiation imaging apparatus in the fourth exemplary embodiment is different from that in the first exemplary embodiment in that the configuration of the radiation shielding member is different. FIG. 5 is a cross-section diagram illustrating an example of a radiation imaging apparatus 400 according to the present exemplary embodiment. In FIG. 5, the same components as those of the radiation imaging apparatus 100 illustrated in FIG. 1 are assigned the same reference numerals, and detailed descriptions thereof are omitted.

Similar to the radiation imaging apparatus 100 according to the first exemplary embodiment, the radiation imaging apparatus 400 includes the sensor panel 101, the sensor support base 102, the electric circuit boards 103, the flexible wire 104, a circuit support base 115, and the housing 106 containing them therein. The first columnar members 108 that fix the circuit support base 115 to the back surface of the housing 106 are provided so that the electric circuit boards 103 face, with a gap, the back surface of the housing 106 opposite to the radiation incident surface in the internal space of the housing 106.

In the radiation imaging apparatus 400, the circuit support base 115 is composed of a radiation shielding member. More specifically, the circuit support base 115 does not have the radiation shielding member separately, but the circuit support base 115 is made of a material including a radiation shielding material, and the circuit support base 115 functioning also as the radiation shielding member is provided. As a high radiation shielding material, the circuit support base 115 desirably includes one or more metallic materials selected from the group consisting of Pb, Ba, Ta, W, and Mo. The circuit support base 115 supports the plurality of electric circuit boards 103 at its lower surface as illustrated in FIG. 5, and the support base 115 is bonded and fixed with the sensor support base 102 by being provided with an adhesive material (not illustrated) as a second fixing portion between the upper surface of the circuit support base 115 and the sensor support base 102. The configuration may be such that, instead of the adhesive material, for example, a screw is used as the second fixing portion to fasten and fix the circuit support base 115 and the sensor support base 102.

In the present exemplary embodiment, the circuit support base 115 itself has a high radiation shielding function.

The electric circuit boards 103 supported by the lower surface of the circuit support base 115 are contained in the circuit support base 115 in a planar view along the radiation incident direction A. Accordingly, the incident radiation is shielded by the circuit support base 115, and the ICs on the electric circuit boards 103 are protected from the radiation. In the present exemplary embodiment, since a radiation shielding member is not separately required, the circuit support base 115 having a high radiation shielding function and the sensor support base 102 can be easily fixed. As a result, the radiation shielding function for the ICs on the electric circuit boards 103 can be surely achieved using the simple circuit support base 115 having a reduced number of components.

The first columnar members 108 are arranged in an area inside the outer periphery of the circuit support base 115 having a radiation shielding function and at positions spaced apart from the ICs on the electric circuit boards 103 in a planar view along the radiation incident direction A. By arranging the first columnar members 108 in the area inside the outer periphery of the circuit support base 115, stable fixation of the circuit support base 115 to the housing 106 is achieved with reduced imbalance in the fixing positions. By arranging the first columnar members 108 at the positions spaced apart from the ICs on the electric circuit boards 103, interference of the first columnar members 108 with the ICs is prevented. In the example in FIG. 5, the first columnar members 108 are arranged in a gap portion between the adjacent electric circuit boards 103. For example, in a case where the electric circuit boards 103 have relatively large areas, through-holes may be formed at positions spaced apart from the ICs on the electric circuit boards 103, and the first columnar members 108 may be arranged so as to pass through the through-holes. By arranging the first columnar members 108 as described above, the circuit support base 115 can be stably fixed to the housing 106 without hindering functions of the ICs on the electric circuit boards 103.

The sensor support base 102 is directly fixed to the circuit support base 115 with an adhesive material or the like as the second fixing portion. In this way, the sensor panel 101, the sensor support base 102, the circuit support base 115, and the electric circuit boards 103 are integrally fixed. Since the circuit support base 115 is fixed to the housing 106 by the first columnar members 108, all of the sensor panel 101, the sensor support base 102, the circuit support base 115, the electric circuit boards 103, and the like are fixed to the housing 106. Thus, both the high radiation shielding property for the electric circuit boards 103 and the sufficient mechanical strength for the sensor panel 101 and the electric circuit boards 103 can be satisfied.

As described above, according to the present exemplary embodiment, in the configuration including the circuit support base 115 that supports the electric circuit boards 103, the radiation imaging apparatus 400 satisfying both the high radiation shielding property for the electric circuit boards 103 and the sufficient mechanical strength for the sensor panel 101 and the electric circuit boards 103 can be achieved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-152275, filed Sep. 4, 2024, which is hereby incorporated by reference herein in its entirety.

What is claimed is:

1. A radiation imaging apparatus comprising:
a radiation detection sensor configured to detect radiation;
an electric circuit board;
a first base including a radiation shielding member located between the radiation detection sensor and the electric circuit board, the first base being configured to support the electric circuit board;
a housing containing the radiation detection sensor, the electric circuit board, and the first base in an internal space of the housing; and
a first fixing portion configured to fix the first base to a back surface of the housing so that the electric circuit board faces the back surface of the housing with a gap in the internal space,
wherein the first fixing portion is located in an area inside an outer periphery of the radiation shielding member in a planar view along a radiation incident direction.

2. The radiation imaging apparatus according to claim 1, wherein the first fixing portion is arranged in the area inside the outer periphery of the radiation shielding member and at a position spaced apart from an integrated circuit on the electric circuit board in the planar view along a radiation incident direction.

3. The radiation imaging apparatus according to claim 1, further comprising a second base configured to support the radiation detection sensor.

4. The radiation imaging apparatus according to claim 3, further comprising a second fixing portion configured to fix the second base in the internal space.

5. The radiation imaging apparatus according to claim 4, wherein the second fixing portion is arranged so as to penetrate the radiation shielding member.

6. The radiation imaging apparatus according to claim 5,
wherein the second base faces the first base via the radiation shielding member, and
wherein the second fixing portion fixes the first base and the second base.

7. The radiation imaging apparatus according to claim 5, wherein the second fixing portion passes through a gap formed in the radiation shielding member.

8. The radiation imaging apparatus according to claim 7,
wherein the gap is formed wider than the second fixing portion, and
wherein the second fixing portion passes through the gap in a state spaced apart from an inner wall surface of the gap.

9. The radiation imaging apparatus according to claim 1, wherein the first fixing portion is formed integrally with the first base.

10. The radiation imaging apparatus according to claim 1, wherein the first fixing portion is formed separately from the first base.

11. The radiation imaging apparatus according to claim 5, wherein the second fixing portion is formed integrally with the first base.

12. The radiation imaging apparatus according to claim 5, wherein the second fixing portion is formed separately from the first base.

13. The radiation imaging apparatus according to claim 5, wherein the second fixing portion is formed integrally with the second base.

14. The radiation imaging apparatus according to claim 5, wherein the second fixing portion is arranged in an imaging effective pixel area of the radiation detection sensor and in an area where an integrated circuit is not arranged on the electric circuit board in the planar view.

15. The radiation imaging apparatus according to claim 5, wherein the first fixing portion and the second fixing portion are arranged at different positions from each other in the planar view.

16. The radiation imaging apparatus according to claim 1, wherein the first fixing portion is fastened and fixed.

17. The radiation imaging apparatus according to claim 4, wherein the second fixing portion is fastened and fixed.

18. The radiation imaging apparatus according to claim 4, wherein the second fixing portion is an adhesive material.

19. The radiation imaging apparatus according to claim 18,
wherein the adhesive material is provided on both surfaces of the radiation shielding member, and
wherein one of the surfaces of the radiation shielding member and the first base are bonded and fixed, and the other of the surfaces of the radiation shielding member and the second base are bonded and fixed.

20. The radiation imaging apparatus according to claim 4, wherein the second fixing portion is a buffer member arranged between the second base and the housing in the internal space to hold the second base to the housing.

21. The radiation imaging apparatus according to claim 19, wherein the second base is in a floating state held by the housing, or in a fixed state fixed to the housing.

22. The radiation imaging apparatus according to claim 1, wherein the first base is configured with the radiation shielding member.

23. The radiation imaging apparatus according to claim 22, wherein the first base is directly fixed to the second base supporting the radiation detection sensor by the second fixing portion fixing the second base in the internal space.

24. The radiation imaging apparatus according to claim 1, wherein the radiation shielding member includes one or more metallic materials selected from the group consisting of lead (Pb), barium (Ba), tantalum (Ta), tungsten (W), and molybdenum (Mo).

25. The radiation imaging apparatus according to claim 3, further comprising another radiation shielding member located between the radiation detection sensor and the second base.
